(19) United States
(12) Patent Application Publication
(10) Pub. No.: US 2015/0227865 A1
(43) Pub. Date: Aug. 13, 2015

(54) CONFIGURATION-BASED REGULATORY REPORTING USING SYSTEM-INDEPENDENT DOMAIN MODELS

(71) Applicant: Microsoft Corporation, Redmond, WA (US)

(72) Inventors: Mikhail Filatov, Moscow (RU); Sergey Shvedov, Moscow (RU)

(73) Assignee: Microsoft Corporation, Redmond, WA (US)

(21) Appl. No.: 14/177,761

(22) Filed: Feb. 11, 2014

(51) Int. Cl. G06Q 10/06; G06F 3/0484; G06Q 30/00; G06F 17/30

(52) U.S. Cl. CPC G06Q 10/067; G06F 17/30091; G06F 17/30126; G06F 3/04842; G06Q 30/018

(57) ABSTRACT

A set of declarative, domain-specific logical models are mapped to one or more different data sources. The declarative, domain-specific logical models are also mapped to an electronic reporting file structure. Changes in the electronic reporting file structure definition are accommodated using declarative inputs to modify the mappings between the declarative, domain-specific logical models and the revised electronic reporting file structure.

### BACKGROUND

Computer systems are currently in wide use. Some such systems are quite large and relatively complicated. They also often have reporting systems which are used to generate reports of the data and other information in the system.

By way of example, some such computer systems include business systems, such as enterprise resource planning (ERP) systems, customer relations management (CRM) systems, line-of-business (LOB) systems, among others. These types of systems allow users to manipulate and control the systems in order to perform various activities, workflows, tasks and other operations in conducting a business. These types of business systems also track information related to the business.

Many organizations that use business systems are subject to regulatory electronic reporting. Regulatory electronic reporting involves the creation of electronic files from a business system, in the formats defined by the governments or other regulatory bodies that require the reports. For instance, government and other regulatory agencies often publish regulations that specify the reporting requirements of various different types of businesses. Some such businesses are multi-national businesses in that they operate in a variety of different jurisdictions around the world. Thus, they can be subject to a wide variety of different types of reporting regulations.

In order to comply with the various types of reporting regulations, such systems often need a consultant, or developer, to configure the compiled code (or imperative code) in the system that is run to generate reports, so that the proper reports are generated. This, however, can be time consuming and cumbersome.

In addition, legislation that defines reporting regulations is subject to relatively frequent changes. For instance, some jurisdictions commonly enact new or modified legislation which affects the regulatory electronic reporting requirements for a given organization. This often means that one or more code developers are employed in order to modify the compiled code that is run to generate the reports, in order to meet the new or modified legislation. Again, this can be cumbersome, time consuming and error prone.

The discussion above is merely provided for general background information and is not intended to be used as an aid in determining the scope of the claimed subject matter.

### SUMMARY

A set of declarative, domain-specific logical models are mapped to one or more different data sources. The declarative, domain-specific logical models are also mapped to an electronic reporting file structure. Changes in the electronic reporting file structure definition are accommodated using declarative inputs to modify the mappings between the declarative, domain-specific logical models and the revised electronic reporting file structure.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative business system architecture.

FIG. 2 is a block diagram of one illustrative logical model mapping generation architecture.

FIG. 3 shows a more detailed block diagram of a regulatory report generator component.

FIG. 4 is a flow diagram illustrating one embodiment of the overall operation of the architectures shown in FIGS. 1 and 2.

FIGS. 4A-1 to 4B-2 are UML diagrams of an exemplary logical model for reporting payments and taxes, respectively.

FIGS. 4C and 4D are illustrative user interface displays.

FIG. 5 is a block diagram showing one embodiment of the architectures illustrated in FIGS. 1 and 2, deployed in a cloud computing architecture.

FIGS. 6-10 show various embodiments of mobile devices.

FIG. 11 is a block diagram of one illustrative computing environment.

### DETAILED DESCRIPTION

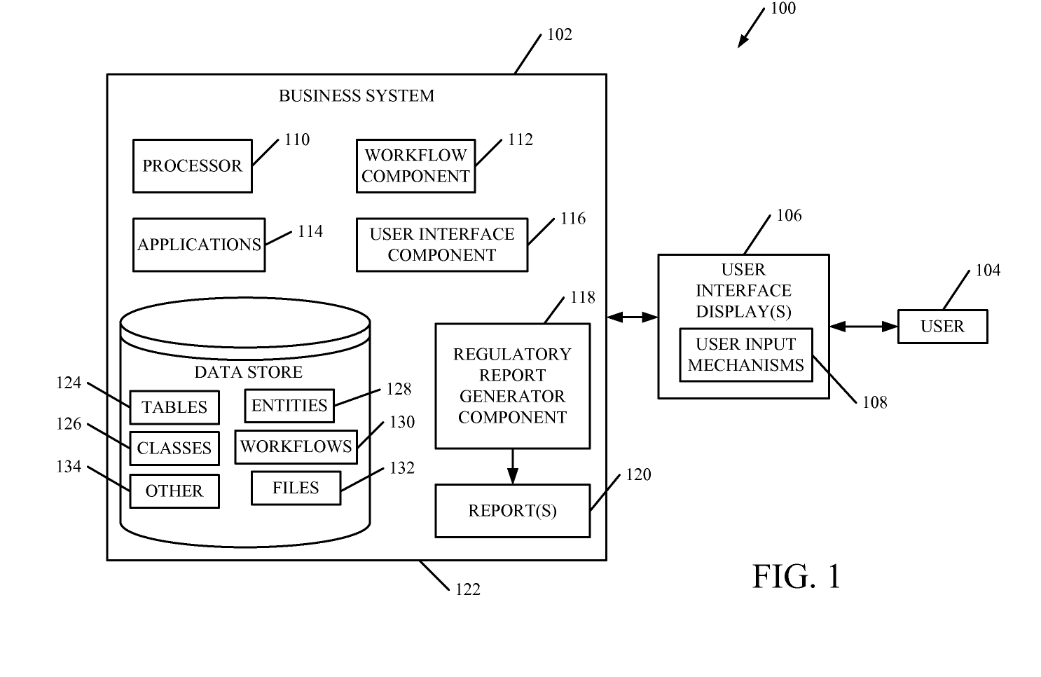

FIG. 1 shows a block diagram of one illustrative business system architecture 100. Architecture 100 includes business system 102 that can be accessed by user 104 (either directly, or through a user device), through a set of user interface displays 106. User interface displays 106 illustratively include user input mechanisms 108 that can be actuated by user 104 in order to access, control and manipulate business system 102.

Business system 102 illustratively includes processor 110, workflow component 112, applications 114, user interface component 116, regulatory report generator component 118 (that is shown generating reports 120), and data store 122. In the embodiment shown, data store 122 illustratively includes tables 124, classes 126, entities 128, workflows 130, files 132 and other data 134. The information in data store 122 is illustratively business information that is used by applications 114 and workflow component 112, in order to allow user 104 to perform various activities, operations or workflows of the business that deploys system 102.

There are a wide variety of different types of business systems, such as ERP systems, CRM systems, LOB systems, etc. In the embodiment described herein, the discussion will proceed with respect to business system 102 being an ERP system, although this is exemplary only. Therefore, applications 114 can include a wide variety of different business applications that are used in an ERP system, such as a general ledger application, an inventory tracking application, various accounting applications, applications that allow a user to track business opportunities, quotes, sales, revenues, applications that compute taxes and payments that are made, and applications that compute a variety of other statistical business information.

Workflow component 112 illustratively performs workflows 130. Workflows 130 can perform automated operations, and can also allow user 104 to direct operations within business system 102. The workflows 130 that are executed by workflow component 112 can include a wide variety of different workflows associated with applications 114, such as generating and paying invoices, generating tax reporting documents and paying taxes, entering items into inventory, documenting sales, as well as a wide variety of other things.

User interface component 116 illustratively generates user interface displays 106 with user input mechanisms 108. Component 116 can generate displays 106, by itself, or under the control of other components or items in business system 102, or outside of business system 102 (such as a user device). Regulatory report generator component 118 illustratively allows user 104 to generate regulatory reports 120 in conformance with report file structure definitions that are defined by various regulatory agencies or bodies, or governments, etc. Reports 120 are thus output in the correct format, in the electronic files that have a structure defined by the regulations. Regulatory report generator component 118 also illustratively uses a plurality of declarative, domain-specific logical models and a declarative approach that allows user 104 to modify the mappings between the domain-specific logical models and the report definitions, to accommodate regulatory changes. This is described in greater detail below.

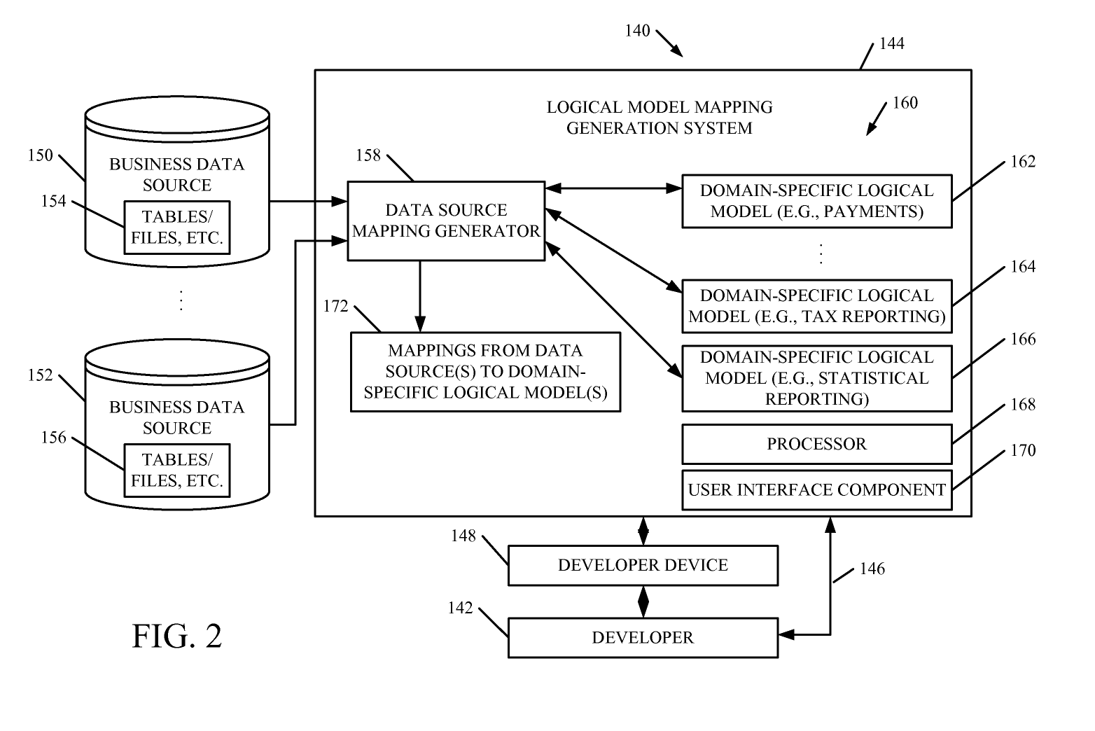

FIG. 2 shows one embodiment of a logical model mapping generation architecture 140. Architecture 140 illustratively shows developer 142 accessing a logical model mapping generation system 144. Architecture 140 is illustratively used by a developer 142 to not only generate a set of domain-specific models, but map them through mappings 172 to one or more data sources. Developer 142 can do this by interacting with system 144 through a set of user interface displays either directly, as indicated by arrow 146, or through a developer device 148.

In the embodiment shown in FIG. 2, system 144 is shown with access to a plurality of different business data sources 150-152 (one of which can also be business data store 122 in business system 102). The business data sources 150-152 each include a set of tables, files, etc. (154 and 156, respectively). The different data sources 150-152 can be a wide variety of different data sources. However, continuing on with the example being discussed, they are illustratively different ERP systems. Therefore, developer 142 can map a set of domain-specific logical models to one or more different ERP systems 150-152.

System 144 illustratively includes data source mapping generator 158 and the set of declarative, domain-specific logical models 160. In one embodiment, domain-specific logical models 160 are product-independent models, meaning that they are not specifically dependent on, or tied to, any given data source 150-152. Instead, they are product-independent so that they can be mapped to a wide variety of different types of data sources.

Also, in one embodiment, the set of domain-specific logical models 160 need not cover all possible regulatory reporting scenarios. Instead, they can illustratively include models in reporting domain areas where reporting is often required, and even domain areas where the reporting regulations often change. In the embodiment described herein, the set of models 160 illustratively includes a payments reporting model 162, a tax reporting model 164, and a statistical reporting model 166, although other domain-specific logical models can be used as well. Payment model 162 is used in generating regulatory reporting around payments. Tax reporting model 164 is used in generating regulatory reporting around taxes, and statistical reporting model 166 is used in generating regulatory reporting around various statistics.

System 144 also illustratively includes processor 168 and user interface component 170. User interface component 170 illustratively generates the set of user interface displays, with user input mechanisms, that allow developer 142 to interact with data source mapping generator 158 to generate the set of mappings 172. Mappings 172 illustratively map one or more of the various data sources 150-152 to the domain-specific logical models 160. The mappings can be generated in imperative code, for example. The logical models 160 are illustratively generated to abstract away from (and thus hide) many of the complexities of the physical data model implemented by the particular source or sources 150-152, to which they are mapped. Because the logical models 160 are product-independent, data source mapping generator 158 can illustratively facilitate different mappings, from different business data sources 150-152 (e.g., from different ERP systems or workflows) to the same logical model.

Once the declarative domain-specific logical models 160 are generated and mapped to one or more data sources 150-152, a declarative approach is illustratively used in order to configure the models so that they generate reports in the legally defined structure of the reporting files for which the reports are generated. Thus, the user that is configuring the reports need not necessarily be a developer 142 or another user that understands the compiled or imperative code, or the relatively complex physical data model in the data sources 150-152. Instead, the declarative approach can illustratively use a formula-driven language (such as the formula-based languages used by common spreadsheet applications) in order to configure the models to generate the proper reports.

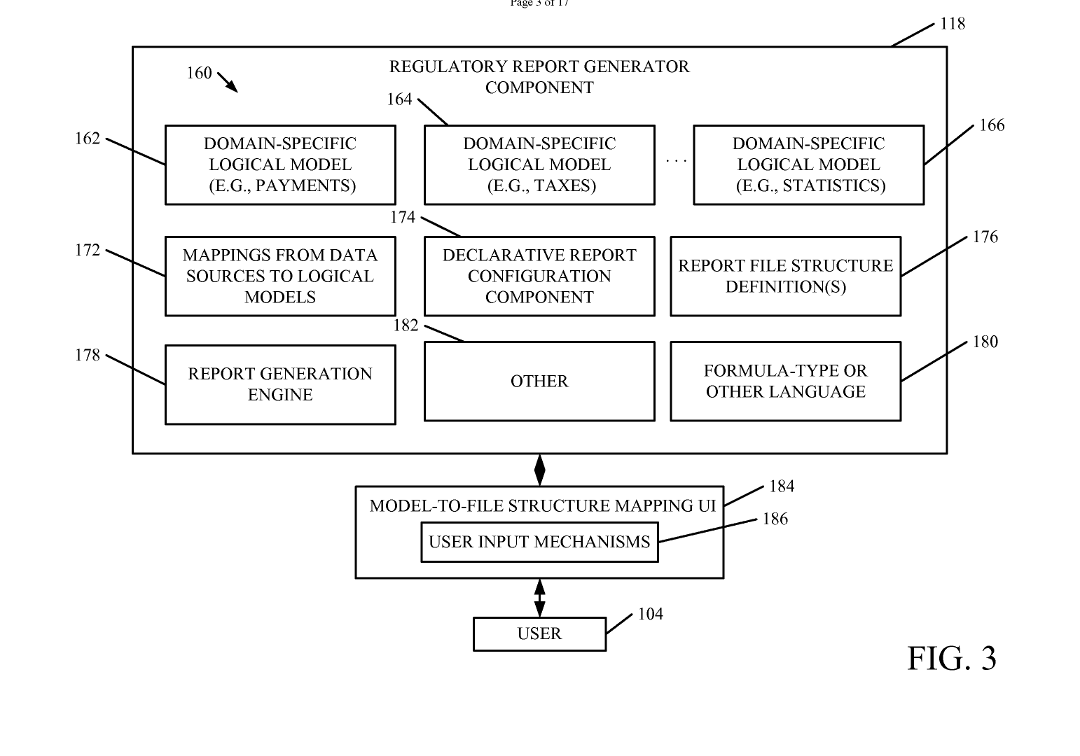

FIG. 3 shows one embodiment of a block diagram of regulatory report generator component 118 (shown in FIG. 1) that can be used by user 104 in order to configure the reports. It can be seen that component 118 illustratively includes the set of domain-specific logical models 160, as well as the mappings 172 that map models 160 to one or more data sources 150-152. Component 118 also illustratively includes declarative report configuration component 174, report file structure definition 176, report generation engine 178, a representation of the formula-type or other language 180 used by component 174, and it can include other components 182 as well.

Declarative report configuration component 174 illustratively generates user interface displays 184 that have user input mechanisms 186 that allow user 104 to map the various domain-specific logical models 160 to the report file structure definitions 176, using declarative programming, so that the reports are generated in conformance with the file structures defined by the various regulatory agencies or bodies. In doing so, declarative report configuration component 174 illustratively allows user 104 to interact with user interface displays using the formula-type language, or other language, that is similar to those used by various spreadsheet applications, in order to configure the report as desired. Once the reports are properly configured, user 104 can invoke report generation engine 178 to generate reports 120 (shown in FIG. 1) at any desired time.

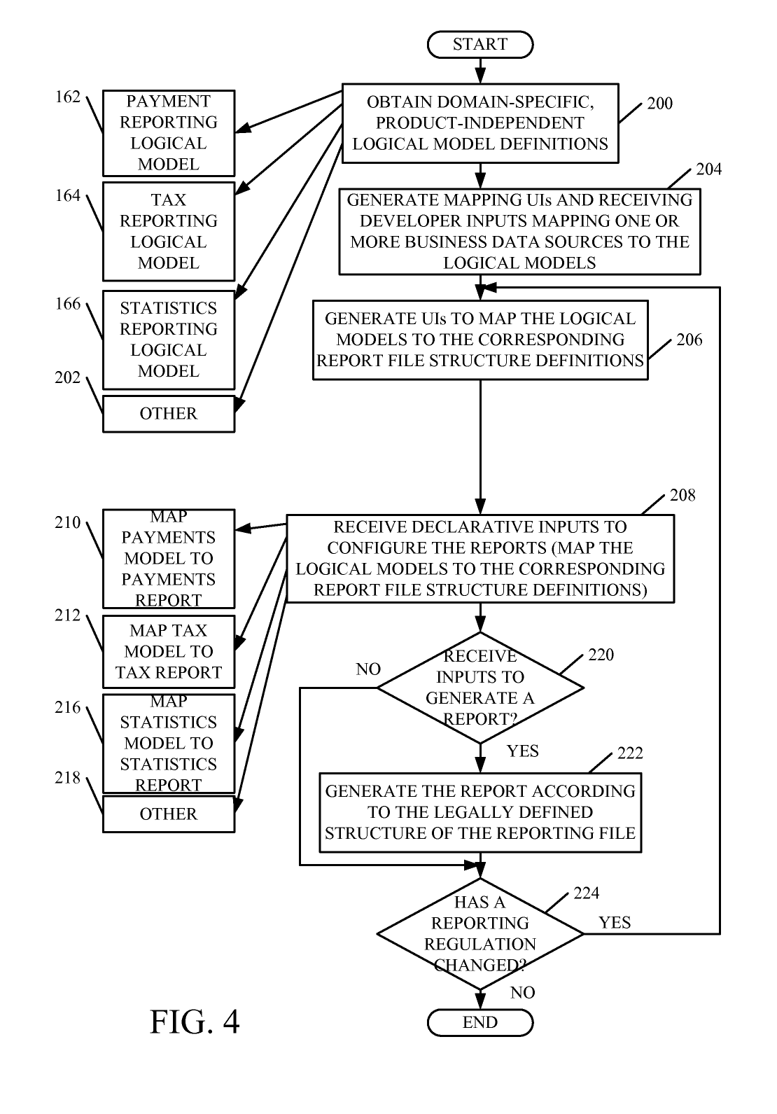

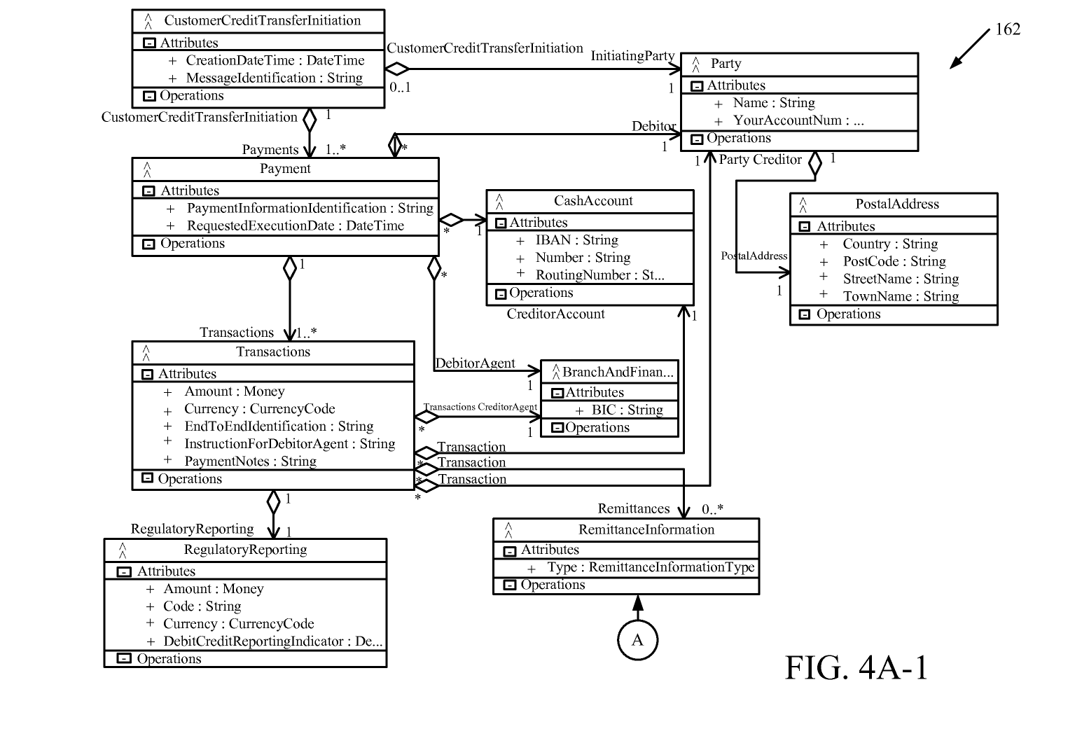

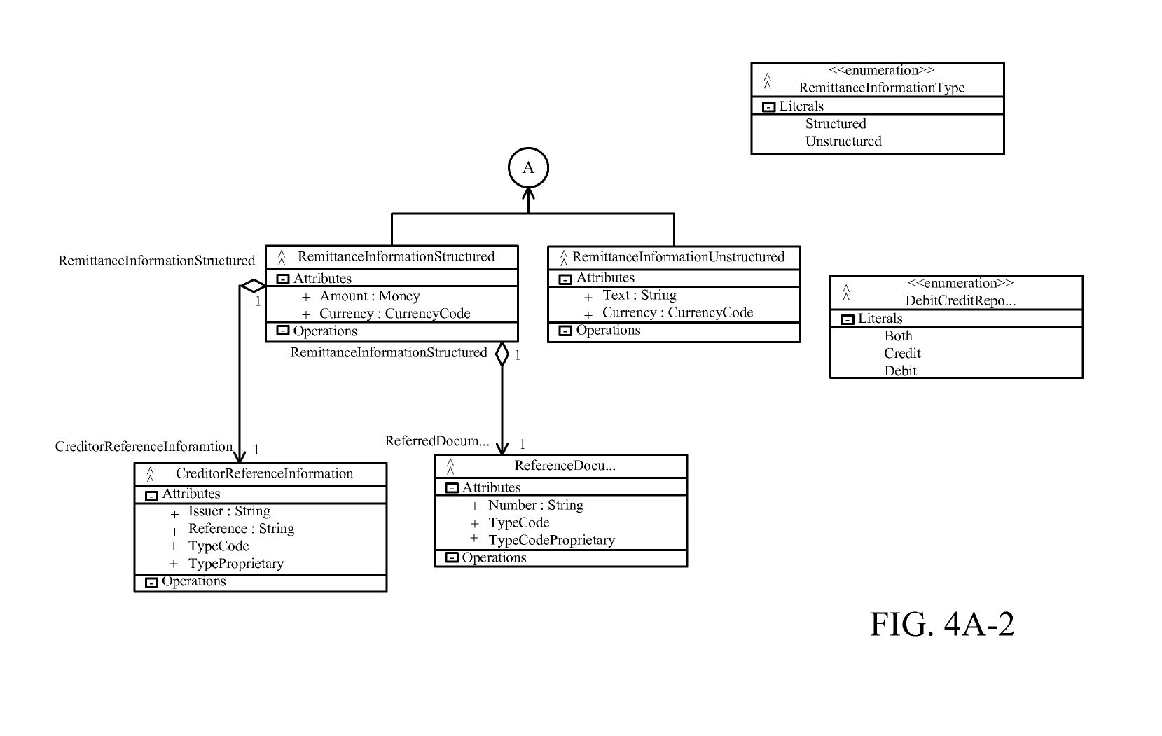

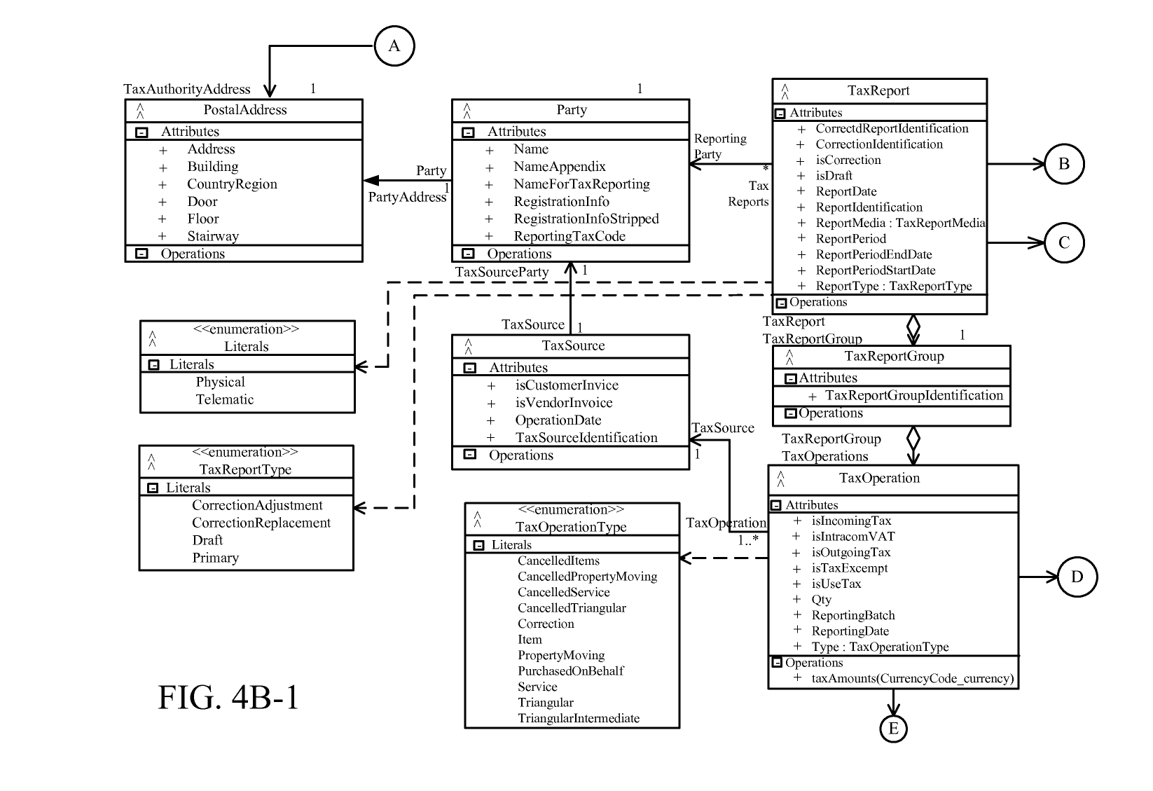

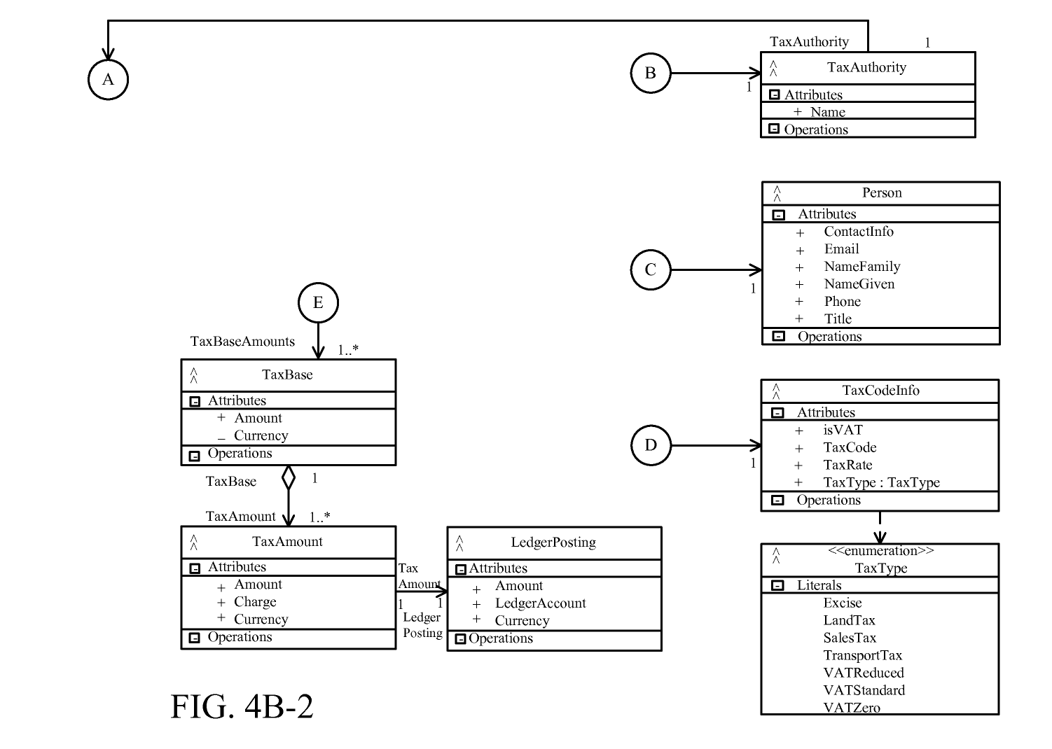

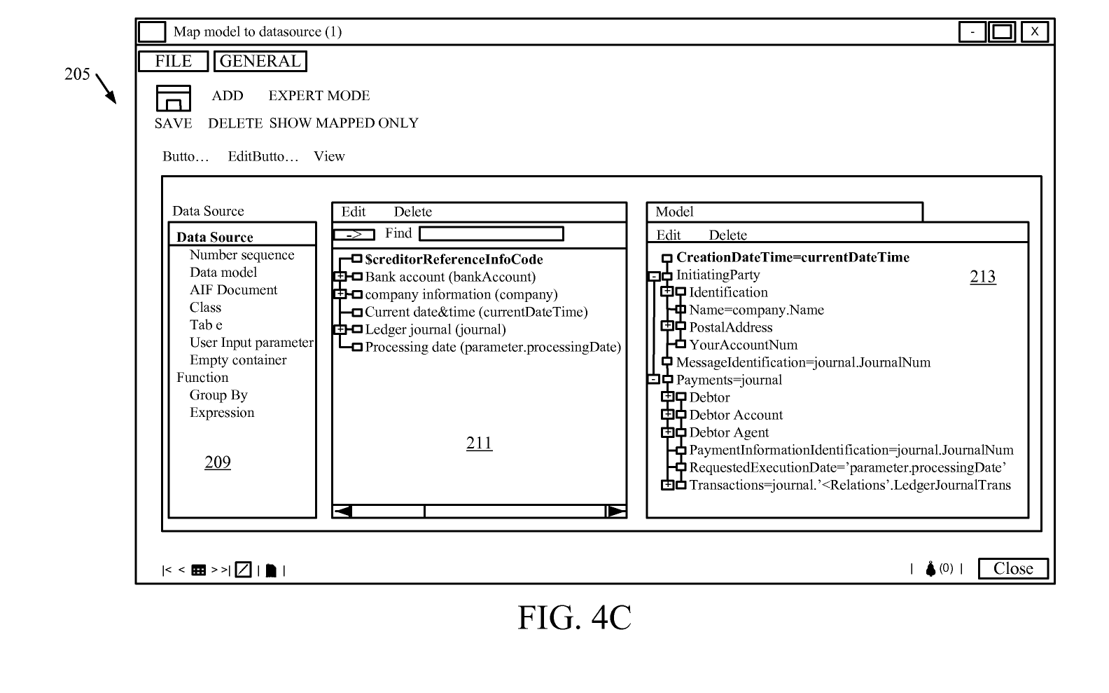

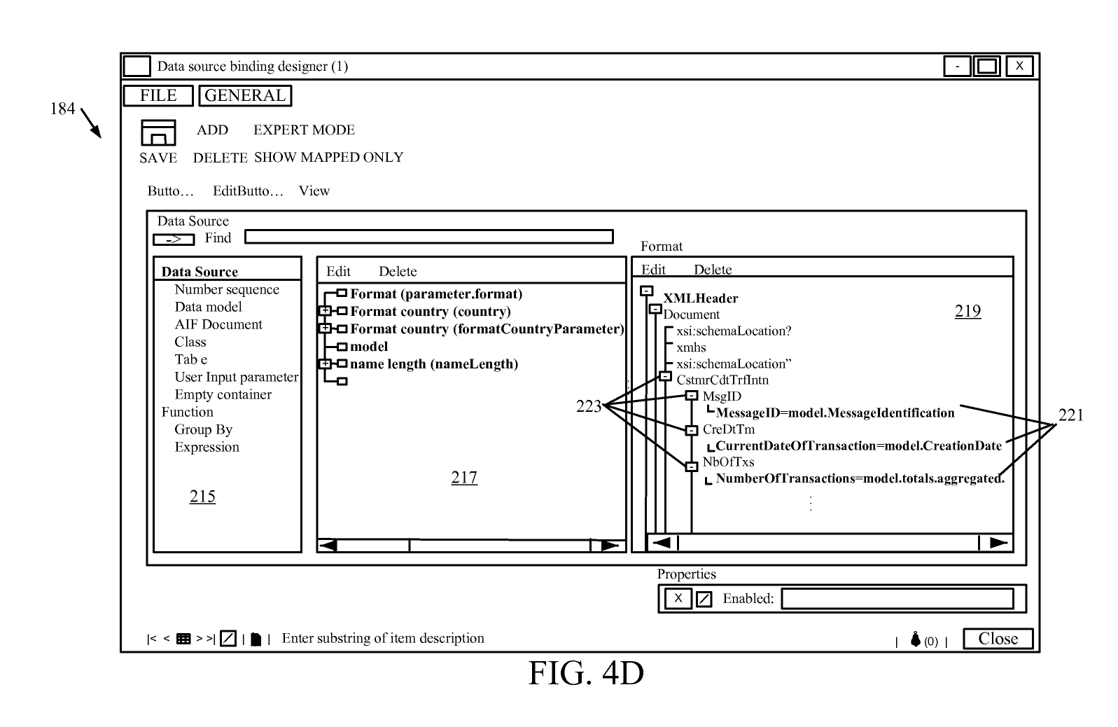

FIG. 4 shows one embodiment of a flow diagram that indicates the overall operation of architectures 100 and 140 shown in FIGS. 1 and 2, and the operation of regulatory report generator component 118 shown in FIG. 3. FIGS. 4A-1 and 4A-2 (collectively FIG. 4A) and 4B-1 and 4B-2 (collectively FIG. 4B) show UML diagrams of two exemplary logical models. The model 162 shown in FIG. 4A is for reporting payments and the model 164 shown in FIG. 4B is for reporting taxes. FIG. 4C is one exemplary user interface display 205 that can be used by developer 142 to map data sources 150-152 to models 160. FIG. 4D is an exemplary user interface display 184 that can be used by user 104 to map the models 160 to the report file structure definitions 176. FIGS. 1-4D will now be described in conjunction with one another.

It is first assumed that the domain-specific, product-independent logical model definitions have already been generated for a set of reporting domains for which changes in regulatory reporting rules are fairly common. Examples of these are shown in the UML diagrams for models 162 and 164 in FIGS. 4A and 4B, respectively. Logical model mapping generation system 144 (in FIG. 2) first obtains the domain-specific, product-independent model definition. This is indicated by block 200 in the flow diagram of FIG. 4. For purposes of the present discussion, it is assumed that the logical model definitions include a declarative logical model for reporting payments, as indicated by block 162. It also includes a declarative tax reporting logical model 164, and a declarative statistics reporting model 166. It can, of course, include other logical models 202 as well.

Data source mapping generator 158 then generates a mapping user interface display (such as display 205 shown in FIG. 4C) with user input mechanisms that receive developer inputs. The developer inputs map one or more business data sources (e.g., 150-152 in FIG. 2) to the set of logical models 160. This is indicated by block 204 in FIG. 4. This can be done in a wide variety of different ways. For instance, the user input mechanisms can include navigation pane 209 that allows the developer 142 to navigate to a set of data sources, for mapping. Based on the selection in pane 209, data source pane 211 shows various data sources that can be mapped to models displayed in model pane 213. The user can thus select a data source and a part of a domain-specific logical model to specify the data source and the particular portion of a domain-specific logical model that it is mapped to. By way of example, it can be seen that the “Name” portion of the logical model shown in pane 211 is mapped to the company.Name data source. As another example, items used in calculating payments that are to be reported in a given format (according to rules promulgated by a regulatory agency or another body) can be mapped to the payments reporting model 162. The information from the data source that is used in calculating taxes can be mapped to tax reporting logical model 164, and the information used to report other business statistics can be mapped to statistics reporting logical model 166. These are discussed by way of example only.

Once mappings 172 are generated by developer 142, declarative report configuration component 174 (shown in FIG. 3) generates user interface displays with user input mechanisms that allow user 104 to map the logical models to the corresponding report file structure definitions 176. This is indicated by block 206 in FIG. 4. The user interface displays generated by component 174 illustratively hide the complexities of the physical data model of the data source to which the underlying logical model is mapped. FIG. 4D shows one embodiment of user interface display 184 that can be used by user 104 to map the logical models 160 to report formats (report file structure definitions 176). User 104 can select a data source in pane 215, and pane 217 displays various different formats. By making a selection in pane 215, pane 217 shows a more detailed view of a report format (e.g., a file structure definition 176). Component 174 illustratively uses formula-type language expressions (or other language expressions) 180 to allow user 104 to declaratively configure the report, and to map the logical models 160 into the report file structure definitions 176. In FIG. 4D, for instance, user 104 can enter formula-type expressions 221, to map the portions of the report file structure definitions 223 to portions of logical models 160.

Thus, it can be seen that component 174 allows user 104 to map the logical models 160 to the report file structure definitions 176 using a declarative approach so that user 104 can be a business user and need not modify any underlying imperative code that is often reserved for developers or other users that have a fairly detailed knowledge of the physical data models in the various business data sources 150-152, and also have a code-level understanding of business system 102. In one embodiment, the formula-type language 180 is the same as, or a variant of, the types of languages used in spreadsheet applications. This is exemplary only, and other formula-type languages can be used as well.

Declarative report configuration component 174 then receives declarative inputs to configure the reports. The inputs serve to map the logical models to the corresponding report file structure definitions. This is indicated by block 208 in FIG. 4. Thus, in one example, the declarative inputs map the payments model 162 to a definition for an electronic payment report, as indicated by block 210. They also map the tax model 164 to an electronic tax report as indicated by block 212. Further, they map the statistics model 166 to an electronic statistics report as indicated by block 216. Of course, they can also map other logical models to other reports, as indicated by block 218.

Regulatory report generator component 118 (in FIG. 3) is now configured to generate reports in the legally defined structure of the various reporting files that are used for the electronic reports. Thus, report generation engine 178 can generate user interface displays with user input mechanisms that allow user 104 to generate reports. Receiving inputs to generate a report is indicated by block 220 in the flow diagram of FIG. 4. In response, report generation engine 178 generates the reports according the legally defined structure of the various reporting files. This is indicated by block 222 in FIG. 4.

At some point, it is assumed that the regulations defining the reports or report formats may be changed, or extended, or otherwise modified. Normally, this would mean that developer 142 would need to modify the imperative code. However, because declarative report configuration component 174 allows user 104 to reconfigure the reports using the declarative models 160, a developer is not needed. Instead, if a reporting regulation change has been made (as indicated by block 224 in FIG. 4), processing simply reverts to block 206 where declarative report configuration component 174 generates user interface displays 184 and user input mechanisms 186 that allow the business user 104 to provide declarative inputs to reconfigure the mappings between the logical models and the corresponding report file structure definitions 176. User 104 can do this using the formula-type (or other) language 180. Since models 160 hide the complexities of the underlying data sources, user 104 need not have extensive knowledge about the physical data model in the data sources in order to reconfigure the mappings between logical models 160 and the report file structure definitions 176, to meet the new regulations. This is done using a declarative approach.

It can thus be seen that the declarative approach to regulatory reporting allows business users to configure regulatory reporting, instead of having a developer rework the underlying imperative code in the business system or in the business data source being used. The domain-specific logical models are not product-specific and are defined in business terms so that business user 104 can understand them, and reconfigure their mappings to the report file structure definitions. The logical models can be generated for domains where reporting regulations change relatively often, such as in the payments domain, the tax reporting domain, and some other statistical reporting domains. User 104 can reconfigure the mappings between the logical models and the report file structure definitions using a relatively straight forward formula-type (or other) language. In addition, while regulatory report generator component 118 is shown as part of business system 102, it can be deployed remotely from business system 102, and accessed by business system 102, as well. For instance, it can be deployed in a cloud computing architecture.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

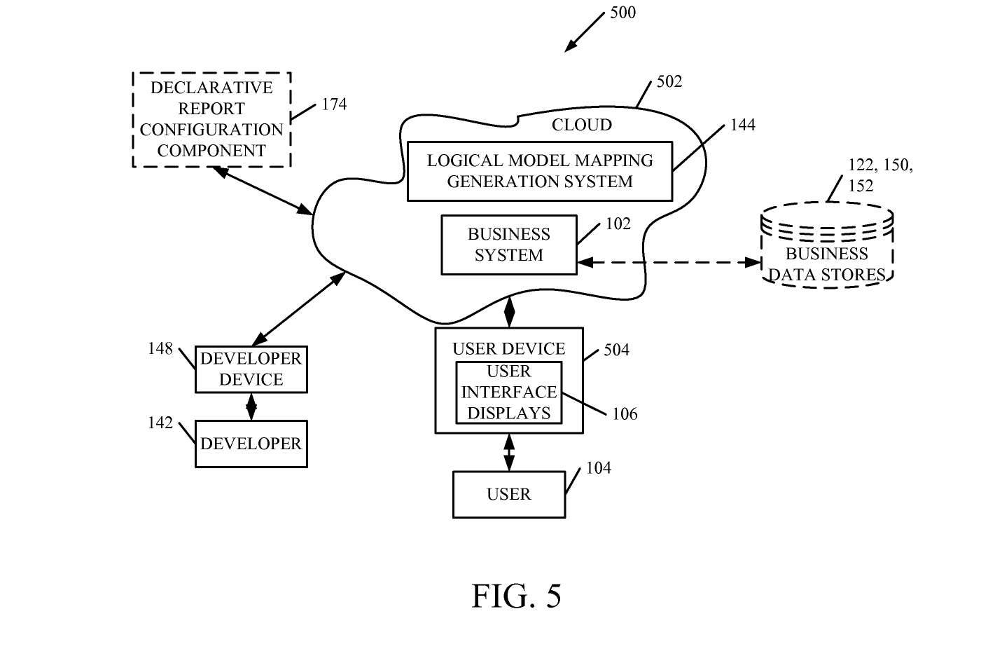

FIG. 5 is a block diagram of architectures 100 and 140, shown in FIGS. 1 and 2, except that the elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architectures 100 and 140 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 5, some items are similar to those shown in FIGS. 1-3 and they are similarly numbered. FIG. 5 specifically shows that systems 102 and 144 can be located in cloud 502 (which can be public, private, or a combination where portions are public while others are private). Therefore, user 104 uses a user device 504, and developer 142 uses developer device 148, to access those systems through cloud 502.

FIG. 5 also depicts another embodiment of a cloud architecture. FIG. 5 shows that it is also contemplated that some elements of architecture 100 and 140 can be disposed in cloud 502 while others are not. By way of example, data sources 150 and 152 can be disposed outside is cloud 502, and accessed through cloud 502. In another embodiment, component 174 is outside of cloud 502. Regardless of where they are located, they can be accessed directly by devices 148 or 504, through a network (either a wide area network or a local area network), they can be hosted at a remote site by a service, or they can be provided as a service through a cloud or accessed by a connection service that resides in the cloud. All of these architectures are contemplated herein.

It will also be noted that architectures 100 and 140, or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

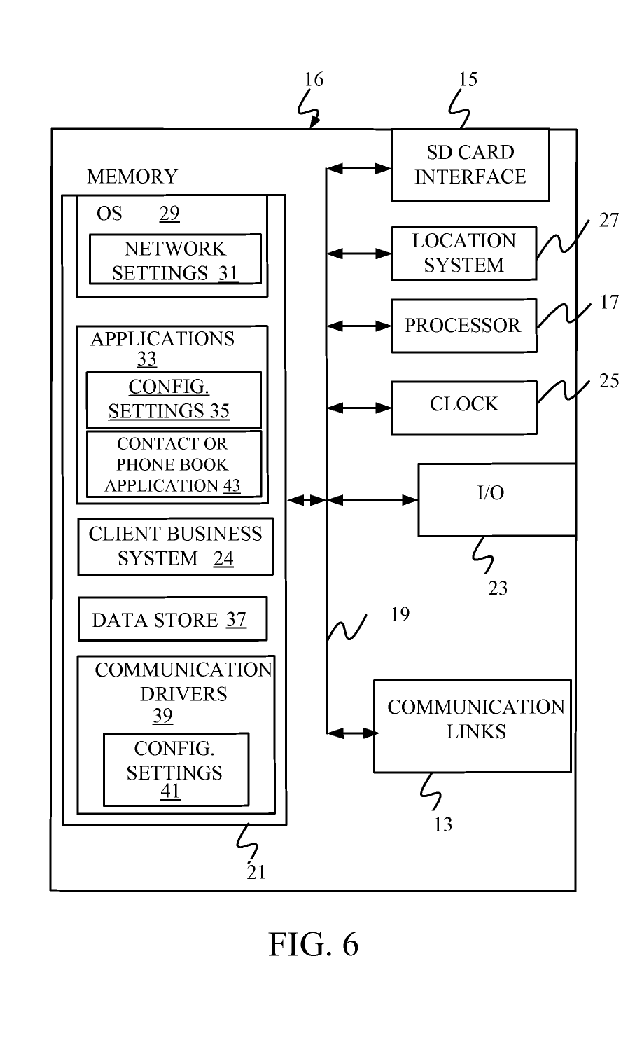

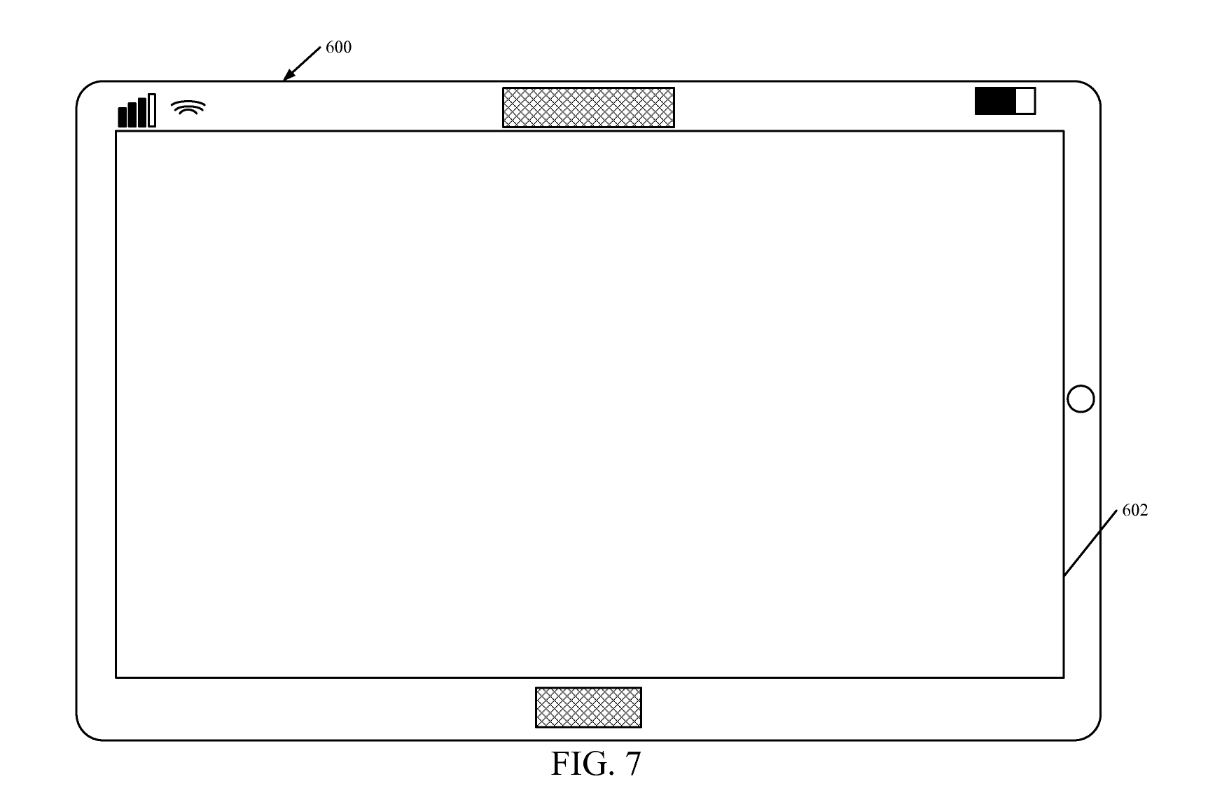

FIG. 6 is a simplified block diagram of one illustrative embodiment of a handheld or mobile computing device that can be used as a user's or client's hand held device 16, in which the present system (or parts of it) can be deployed. FIGS. 7-10 are examples of handheld or mobile devices.

FIG. 6 provides a general block diagram of the components of a client device 16 that can run components of architecture 100 and 140 or that interacts with architectures 100 and 140, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 110 or 160 from FIGS. 1 and 2) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

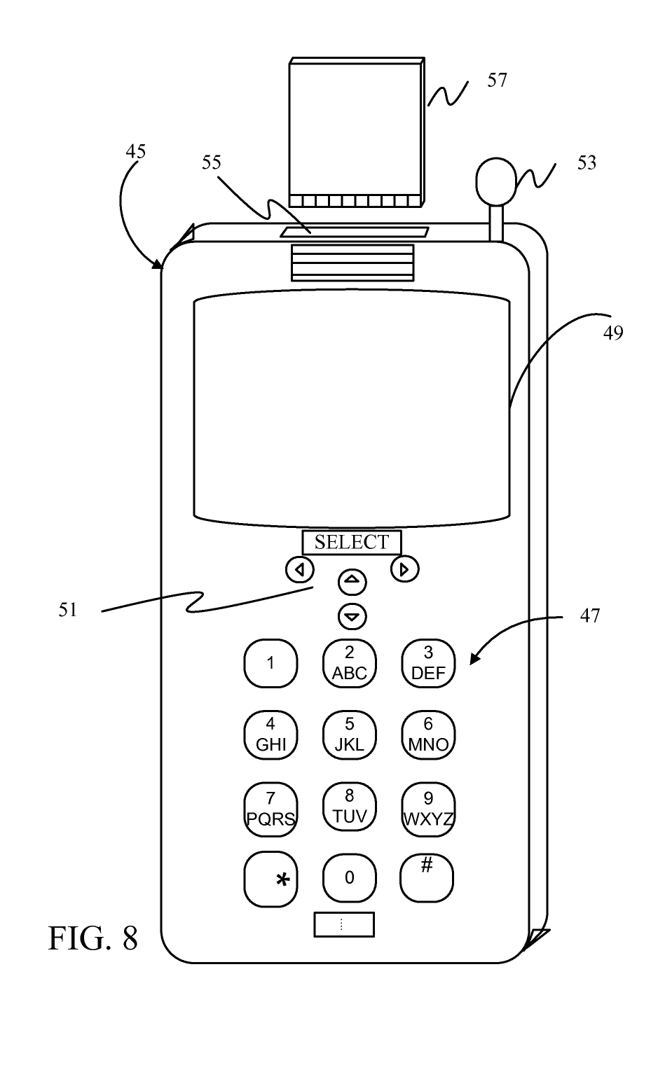

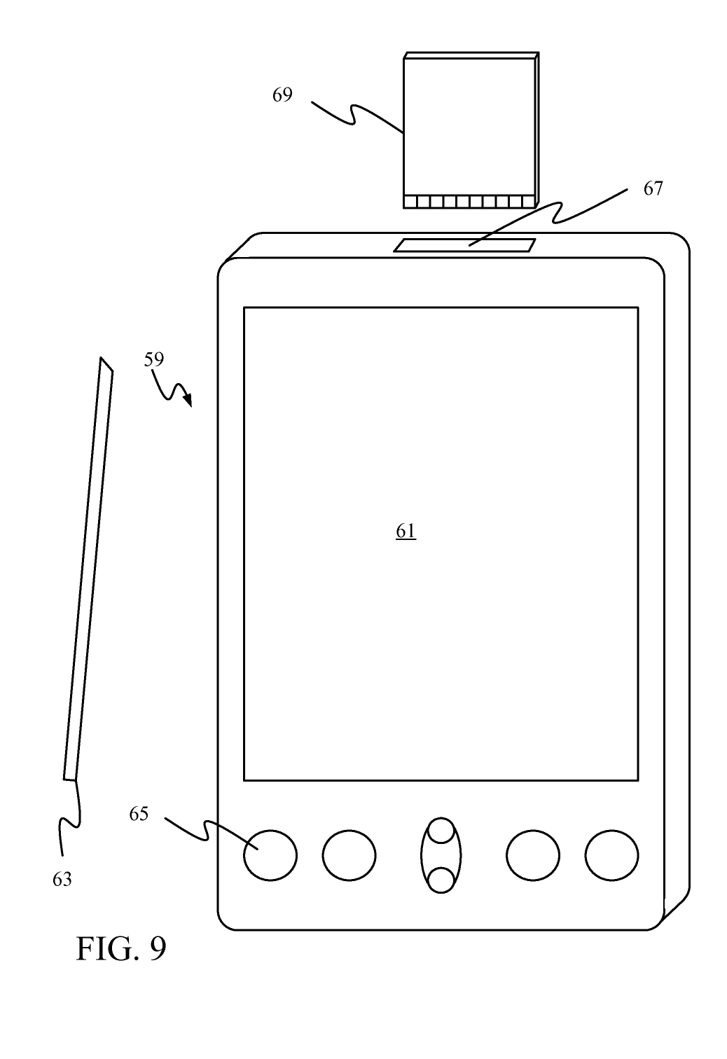

FIGS. 8 and 9 provide additional examples of devices 16 that can be used, although others can be used as well. In FIG. 8, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 9 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

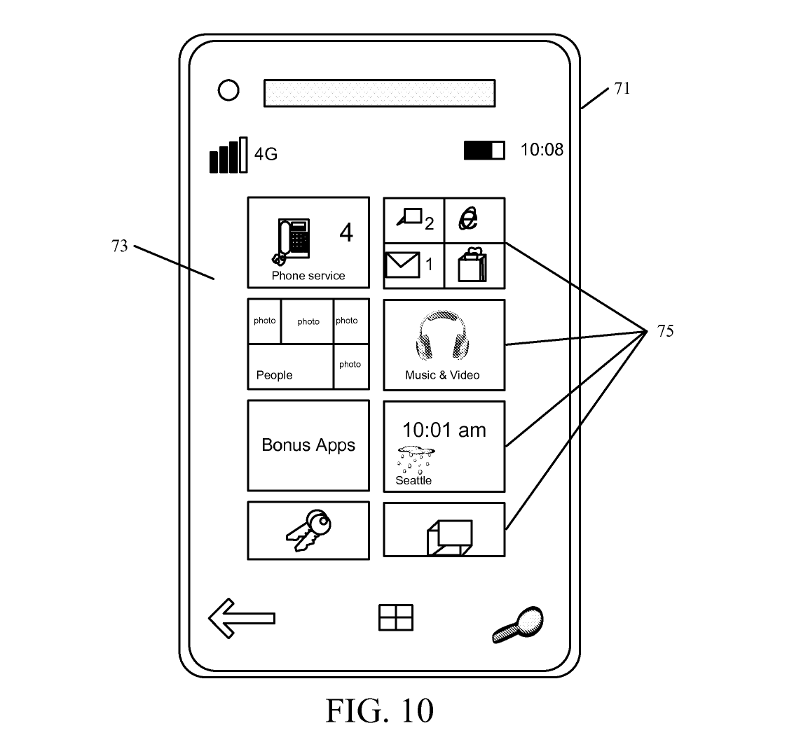

FIG. 10 is similar to FIG. 8 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

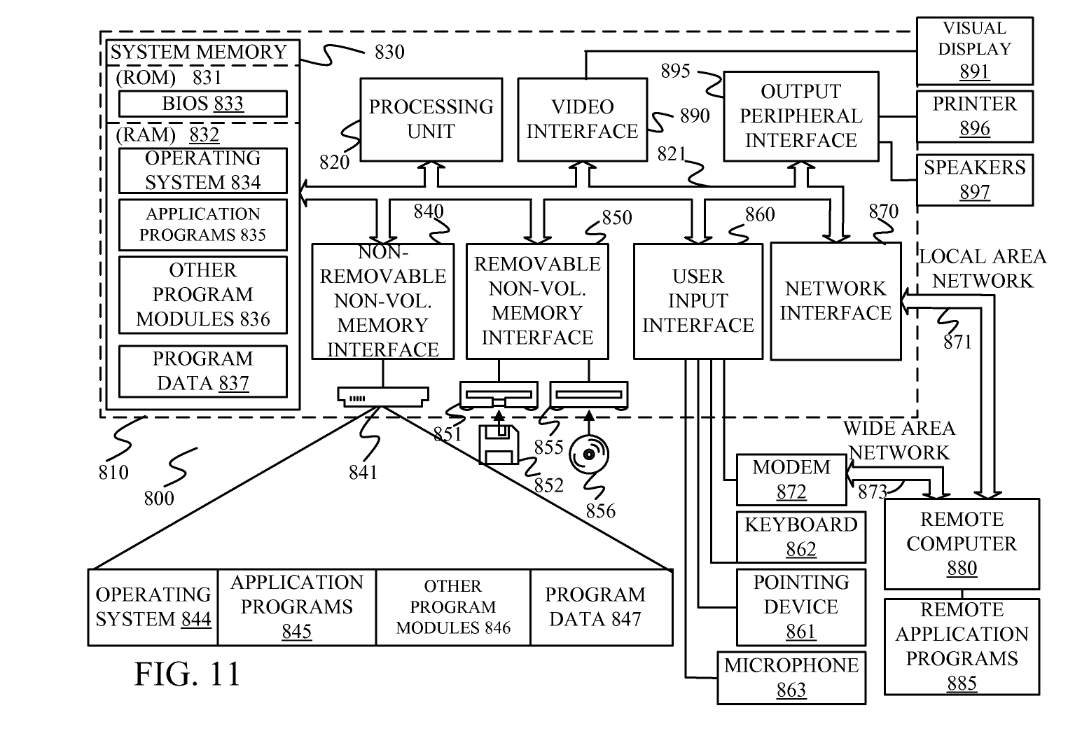

FIG. 11 is one embodiment of a computing environment in which architectures 100 or 140, or parts of them, (for example) can be deployed. With reference to FIG. 11, an exemplary system for implementing some embodiments includes a general-purpose computing device in the form of a computer 810. Components of computer 810 may include, but are not limited to, a processing unit 820 (which can comprise processors 110 or 168), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIGS. 1-3 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
displaying a logical model-to-file structure mapping user interface display with user input mechanisms that receive declarative user mapping inputs;
generating a first mapping that maps a set of domain-specific declarative logical models to a set of report file structure definitions, each corresponding to a report, based on the declarative user mapping inputs;
receiving user report generation inputs indicating a given report; and
generating the given report according to the corresponding report file structure definition, based on the first mapping.

2. The computer-implemented method of claim 1 wherein generating the given report comprises:
obtaining data from a business system data source, through the set of domain-specific declarative logical models, using a second mapping that maps the business system data source to the set of domain-specific declarative logical models.

3. The computer-implemented method of claim 2 wherein the set of domain specific declarative logical models comprises a set of reporting domain models, each reporting domain model being specific to a reporting domain, and wherein generating the given report comprises:
obtaining the data from the business system data source through the set of reporting domain models, using the second mapping; and
generating the given report using the first mapping.

4. The computer-implemented method of claim 3 wherein the set of reporting domain models comprises a tax reporting model that maps tax reporting data from the business system data source to a tax reporting file structure definition corresponding to a tax report, and wherein generating the given report comprises:
obtaining the tax reporting data from the business system data source, based on the second mapping, through the tax reporting model; and
generating the tax report based on the first mapping.

5. The computer-implemented method of claim 3 wherein the set of reporting domain models comprises a payment reporting model that maps payment reporting data from the business system data source to a payment reporting file structure definition corresponding to a payment report, and wherein generating the given report comprises:
obtaining the payment reporting data from the business system data source , based on the second mapping, through the payment reporting model; and
generating the payment report based on the first mapping.

6. The computer-implemented method of claim 3 wherein the set of reporting domain models comprises a business statistics reporting model that maps statistical business reporting data from the business system data source to a statistics reporting file structure definition corresponding to a business statistics report, and wherein generating the given report comprises:
obtaining the statistical business reporting data from the business system data source, based on the second mapping, through the business statistics reporting model; and
generating the business statistics report based on the first mapping.

7. The computer-implemented method of claim 2 and further comprising:
generating a user interface display with data source mapping user input mechanisms; and
receiving developer inputs through the data source mapping user input mechanisms to define the second mapping from the business system data source to the set of domain-specific declarative logical models.

8. The computer-implemented method of claim 1 and further comprising:
receiving a revised set of report file definition structures;
displaying the logical model-to-file structure mapping user interface display with the user input mechanisms that receive revised declarative user mapping inputs; and
reconfiguring the first mapping that maps the set of domain-specific declarative logical models to the revised set of report file structure definitions based on the revised declarative user mapping inputs.

9. The computer-implemented method of claim 8 and further comprising:
receiving user report generation inputs indicating the given report; and
generating the given report according to the corresponding revised report file structure definition, based on the reconfigured first mapping.

10. A computer system, comprising:
a regulatory report generator component that generates a mapping user interface display with a user input mechanism that receives declarative mapping user inputs to map data to a report file structure definition; and
a computer processor that is a functional part of the system and activated by the regulatory report generator component to facilitate generating the mapping user interface display, receiving the declarative mapping user inputs, mapping the data to the report file structure definition, and generating reports according to the report file structure definition.

11. The computer system of claim 10 wherein the regulatory report generator component comprises:
a set of declarative, domain-specific logical models that are mapped, with an imperative code mapping, to a business system data source.

12. The computer system of claim 11 wherein the regulatory report generator component comprises:
a declarative report configuration component that generates a declarative code mapping that that maps the set of declarative, domain-specific logical models to the report file structure definition based on the declarative mapping user inputs.

13. The computer system of claim 12 wherein the set of declarative, domain-specific logical models comprise:
a tax reporting model that maps tax reporting data from the business system data source to a tax report file structure definition corresponding to a tax report based on the imperative code mapping and the declarative code mapping.

14. The computer system of claim 12 wherein the set of declarative, domain-specific logical models comprise:
a payment reporting model that maps payment reporting data from the business system data source to a payment report file structure definition corresponding to a payment report based on the imperative code mapping and the declarative code mapping.

15. The computer system of claim 12 wherein the set of declarative, domain-specific logical models comprise:
a business statistics reporting model that maps business statistics reporting data from the business system data source to a business statistics report file structure definition corresponding to a business statistics report based on the imperative code mapping and the declarative code mapping.

16. The computer system of claim 12 wherein the report file structure definition is prescribed by reporting regulations of a regulatory body.

17. The computer system of claim 12 wherein the regulatory report generator component further comprises:
a report generation engine that receives report generation user input and generates a given report using one of the set of declarative, domain-specific logical models, according to a corresponding report file structure definition.

18. A computer readable storage medium that stores computer executable instructions which, when executed by a computer, cause the computer to perform a method, comprising:
displaying a logical model-to-file structure mapping user interface display with user input mechanisms that receive declarative user mapping inputs;
generating a first mapping that maps a set of domain-specific declarative logical models to a set of report file structure definitions, each corresponding to a report, based on the declarative user mapping inputs;
receiving user report generation inputs indicating a given report;
obtaining data from a system data source, through the set of domain-specific declarative logical models, using a second mapping that maps the system data source to the set of domain-specific declarative logical models; and
generating the given report according to the corresponding report file structure definition, based on the first mapping.

19. The computer readable storage medium of claim 18 wherein the system data source comprises a business system data source, and further comprising:
receiving a revised set of report file definition structures;
displaying the logical model-to-file structure mapping user interface display with the user input mechanisms that receive revised declarative user mapping inputs; and
reconfiguring the first mapping that maps the set of domain-specific declarative logical models to the revised set of report file structure definitions based on the revised declarative user mapping inputs.

20. The computer readable storage medium of claim 19 wherein the set of domain-specific declarative logical models comprises a tax reporting model that maps tax reporting data from the business system data source to a tax reporting file structure definition corresponding to a tax report, and a payment reporting model that maps payment reporting data from the business system data source to a payment reporting file structure definition corresponding to a payment report and wherein generating the given report comprises:
obtaining the tax reporting data from the business system data source, based on the second mapping, through the tax reporting model;
obtaining the payment reporting data from the business system data source , based on the second mapping, through the payment reporting model; and
generating the tax report and the payment report based on the first mapping.
